(19) United States
(12) Patent Application Publication
(10) Pub. No.: US 2015/0117800 A1
(43) Pub. Date: Apr. 30, 2015

(54) TUBULAR BAG HAVING A WINDOW

(71) Applicant: Hood Packaging Corporation, Hattiesburg, MS (US)

(72) Inventor: Andrew G. Petersen, Bennington, NE (US)

(21) Appl. No.: 14/063,050

(22) Filed: Oct. 25, 2013

(51) Int. Cl. B65D 33/04; B31B 19/62

(52) U.S. Cl. CPC B65D 33/04; B31B 19/62
USPC 383/106; 493/264

(57) ABSTRACT

Described are tubular bags having a window, wherein and an outer layer along with the window is a polymer film and a paper layer is adjacent to the outer layer. The polymer film may contain indicia to convey information about the goods inside. The polymer film may be reverse printed to provide clear, detailed, and even vividly-colored graphics. The bags also provide a window made from the same polymer film for reviewing the contents inside. A paper layer adjacent the polymer film layer is made from paper, for example kraft paper, which lends strength to the bag. A reinforcement member is optionally used to provide further strength and structure.

### TECHNICAL FIELD

The present disclosure relates to tubular bags having a window, wherein and an outer layer along with the window is a polymer film and a paper layer is adjacent to the outer layer.

### BACKGROUND

Designs of bags for packaging goods vary widely to accommodate wide-ranging applications. Not only do the bags need to properly contain the goods, but there is also a need to convey information about the goods inside. Windows may be incorporated into the bag structure. Also, suppliers generally like to be able to provide clear, detailed, and even vividly-colored graphics on their products. Printing indicia onto paper has limitations on how clear, detailed, and vivid the information appears.

Bags having laminate structures are usually formed by layers of materials that may be different or the same. Tubular bags are usually formed by a laminated structure rolled and sealed into a tube that is then cut to length and closed up, as desired.

There is an on-going need to provide cost-effective bags for delivery of goods that utilize both paper and plastic and permit the use of windows and/or indicia to convey information.

### SUMMARY

In view of limitations encountered by printing indicia onto paper surfaces of bags, provided herein are bags having an outer layer made from a polymer film that may contain indicia to convey information about the goods inside. The polymer film may be reverse printed to provide clear, detailed, and even vividly-colored graphics. The bags also provide a window made from the same polymer film for reviewing the contents inside. A paper layer adjacent the polymer film layer is made from paper, for example high quality kraft paper, which lends strength to the bag. A reinforcement member is optionally used to provide further structure.

In an aspect, provided are tubular bag for containing a product, the bag comprising: a laminate structure that comprises an outer layer comprising a polymer film and a paper layer adjacent the outer layer; a window integral to the laminate structure, the window comprising the polymer film of the outer layer; a lap seam; a bottom seal to form a closed end of the bag; and a fill end opposite the closed end.

Other features that may be used individually or in combination with respect to any aspect of the invention are as follows.

The tubular bag may further comprise a reinforcement member at the closed end of the bag. The reinforcement member may cover the bottom seal. The reinforcement member may comprise paper alone or in combination with a polymer film.

The bottom seal may comprise a pinch bottom, a rolled bottom, or a block bottom. The polymer film may be reverse-printed with indicia. The polymer film may comprise polyester, nylon, polypropylene, or polyethylene. The paper may comprise kraft paper having a weight in the range of from about 40 lb. to about 60 lb. per ream. The bag may have a width in the range of from about 8 inches (20 cm) to about 22 inches (56 cm) and a length in the range of about 18 inches (46 cm) to about 42 inches (107 cm). The bag may further comprise at least two side gussets along the length of the bag, the gussets extending inwardly at a distance from the side of the bag in the range of from about 2 inches (5 cm) to about 12 inches (30 cm). The bag may further comprise a fill end closure for sealing or optionally resealing the fill end. The fill end closure may comprise a hot melt adhesive seam, a heat seal seam, a sewn seam, a rolled glue seam, or a pressure sensitive adhesive with a liner. The window may run the length of the bag. The window may form up to about 25% of the surface area of the bag.

In some embodiments, the paper layer may be a product-contacting layer. In other embodiments, the bag may further comprise a barrier layer adjacent the paper layer, where the barrier layer is a product-contacting layer.

In a detailed aspect, a tubular bag comprises: a laminate structure that comprises a product-side layer and an outer layer, the product-side layer comprising paper that is kraft paper having a weight in the range of from 40 lb. to about 60 lb. and the outer layer comprising a polymer film that is a polyester film, a polypropylene film, or a nylon film, wherein an adhesive adheres the polymer film to the paper and wherein the outer layer comprises indicia; a window integral to the laminate structure, the window comprising the polymer film of the outer layer; a lap seam; a pinch bottom seal to form a closed end of the bag; and a fill end opposite the closed end. The polymer film may be a polyester film that is polyethylene terephthalate (PET). The bag may further comprise a fill end closure that comprises a polyamide hot melt adhesive. The indicia may be reverse-printed on the polymer film.

Another aspect provides a method of making a tubular bag, the method comprising: unwinding a roll of a polymer film; unwinding a roll of paper and slitting the paper to form a gap; applying an adhesive to the polymer film and optionally drying the adhesive; laminating the polymer film and the paper such that a laminated structure with an integral window is formed; forming a lap seal to form a tubular bag; and sealing one end of the bag to form a closed end. The method may further comprise affixing a reinforcement member to the closed end of the bag. The polymer film may comprise indicia. The method may further comprise forming a fill end closure.

In an aspect, provided is a method of providing dry goods, the method comprising: obtaining a tubular bag disclosed herein; packaging the dry food in the bag; and closing the fill end. The dry goods may comprise rice, whey products, or flour products.

These and other aspects of the invention are described in the detailed description below. In no event should the above summary be construed as a limitation on the claimed subject matter.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic perspective view of an exemplary tubular bag showing a fill end that is open;

FIG. 2 is a cross-section view of the tubular bag;

FIG. 3 is a schematic perspective view of an exemplary tubular bag whose fill end is closed with a closure;

FIGS. 4-6 are schematic drawings of various different bottom seals; and

FIG. 7 is a schematic of the reinforcement member.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

Provided are tubular bags having a window, wherein an outer layer along with the window is a polymer film and a paper layer is adjacent to the polymer film. Methods of making and using the same are also provided. Providing a window that is the same material as the outer layer and integral to the laminate structure facilitates manufacturing and avoids an extra step of separately affixing a window.

The styles of tubular bags that are amenable to this disclosure include, but are not limited to pinch bottom open mouth (PBOM) bags, sewn open mouth bags (SOM), pasted valve bags, self opening satchels (SOS), and block bottom bags.

Reference to “outer layer” as used herein refers to the portion of the bag that is handled when the bag is closed. The outer layer is generally exposed to the external environment surrounding the bag.

Reference to “product-contacting layer” as used herein refers to the portion of the bag that directly contacts the product that is packaged in the bag. For dry goods, a product-contacting layer may be paper. For greasy or wet goods, a barrier layer is needed to protect any paper layers present. Barrier layers are typically a polymer film.

A “laminate structure” is one that has multiple layers secured together that may be the same or different.

“Tubular” refers to the shape of a structure that is formed into a tube and sealed with a seam, for example, a lap seam.

A “pinch bottom” is one that is formed by applying an adhesive (e.g., glue) to a bottom end of a structure such as a tubular laminate structure, folding over that end, and applying pressure to that end to form a pinch.

A “rolled bottom” is one that is formed by rolling over one end of a structure, for example a tubular laminate structure, and applying adhesive to the rolled-over end. The end may be rolled again. Pressure is applied to the once- or twice-rolled end to form the seal.

A “block bottom” is formed by folding in and adhering portions of a laminate structure to form a square or rectangle bottom.

A “fill end closure” is a structure that permits the fill end to be closed after filling with product.

### Materials

Examples of suitable paper may include a wide variety of grades, but for purposes of containing and contacting dry goods, it is preferred that kraft paper be used. In some embodiments, a high performance kraft paper that has improved strength properties may be used. Weight of the paper is in the range of 40-60 pounds per ream, which as understood in the art means that under conditions of 50% relative humidity at 23° C., the paper has a basis weight in the range of 40 to 60 lb/3000 ft². Any color, such as white or natural, may be chosen.

Suitable polymeric films and barrier layers may be monolayer or multilayer, coextruded or laminated, and/or any desired configuration appropriate to the end use. For foodstuffs, the films would be FDA-compliant accordingly. Material for the films include, but are not limited to, polyester (for example: polyethylene terephthalate (PET)), nylon, polypropylene, and polyethylene.

The polymeric films may be adhered to the paper by methods known in the art, for example by use of an adhesive. An adhesive may be water-based or non-water based. Suitable adhesives include, but are not limited to: an acrylic-based adhesive or a urethane-based adhesive. The adhesive may be applied to the polymer film by rotogravure.

Adhesives for the bottom seal and the fill end closure may be chosen as needed based on the paper and polymer film(s) being used. Suitable adhesives may be water based or non-water based or solventless based. An exemplary bottom seal or fill end closure may use a polyamide hot melt that meets the ingredient requirements of Indirect Food Additives Regulation 21 CFR §175.105.

Materials for the reinforcement member include, but are not limited to: high quality kraft paper, a composite of paper and polymer like the laminate structure, and clay-coated kraft paper.

### Features

The bag size may have a width in the range of from about 8 inches (20 cm) to about 22 inches (56 cm) and a length in the range of about 18 inches (46 cm) to about 42 inches (107 cm).

The window may have a width in the range of 0.5 inches (1.3 cm) to about 0.75 inches (1.9 cm). The window may form up to about 25% of the surface area of the bag (or 5-10% or 2-25% or even up to 30%, 40%, or even 50%).

Bottom seals may be formed as needed. In detailed embodiments, the bottom seal comprises a pinch bottom, a rolled bottom, or a block bottom as depicted in FIGS. 4-6.

Gussets features are optional, but when they are used, they extend inwardly at a distance from the side of the bag in the range of from about 2 inches (5 cm) to about 12 inches (30 cm).

The reinforcement member provides added structure to the bottom seal of the bag. It may cover all or a portion of the bottom seal. It may have indicia as needed. The reinforcement member also terminates the window/transparent area of the bag.

As for fill end closures, they are applied or provided during fabrication of the bag, and then used by the customer after filling to seal the bag. Exemplary fill end closures closure is a hot melt adhesive that may be applied while the bag is being made, and then it is reactivated once the bag is filled. Other examples of closures include, but are not limited to, a heat seal or heat seal seam, a sewn seam, a rolled glue seam, or a pressure sensitive adhesive with a liner. The closure may be prepared at the time of bag manufacture or alternatively after filling.

The bags will possess strength characteristics to comply with application-specific puncture and drop requirements.

### Fabrication

In general terms, to form bags disclosed herein, the following steps are used.

1. Obtain a polymer film on a roll for the outer layer. Reverse print ink from a graphic template onto the polymer film as needed to provide indicia.

2. Obtain paper on a roll, for example, high performance kraft paper. Unwind the paper and slit it to create a window lane.

3. Laminate the paper to the polymer film using an adhesive. For example, use an adhesive applied via rotogravure.

4. Convert the film/paper laminate structure into a tube having a factory end or pinch bottom. A tuber bottomer may be used, which is a machine designed for the purpose of achieving both a tube and a factory end in one step. Alternatively, separate machines may be used to form the tube and the bottom.

5. Apply a reinforcement member, or patch, to the factory end seal by, for example, adhering it using a polyamide hot melt, to bridge the film in the paper gap to provide stiffness.

6. The factory end seal covered by the patch is then folded and compressed.

An exemplary process for making bags is provided in U.S. Pat. No. 3,203,323.

Before describing several exemplary embodiments of the invention, it is to be understood that the invention is not limited to the details of construction or process steps set forth in the following description. The invention is capable of other embodiments and of being practiced or being carried out in various ways.

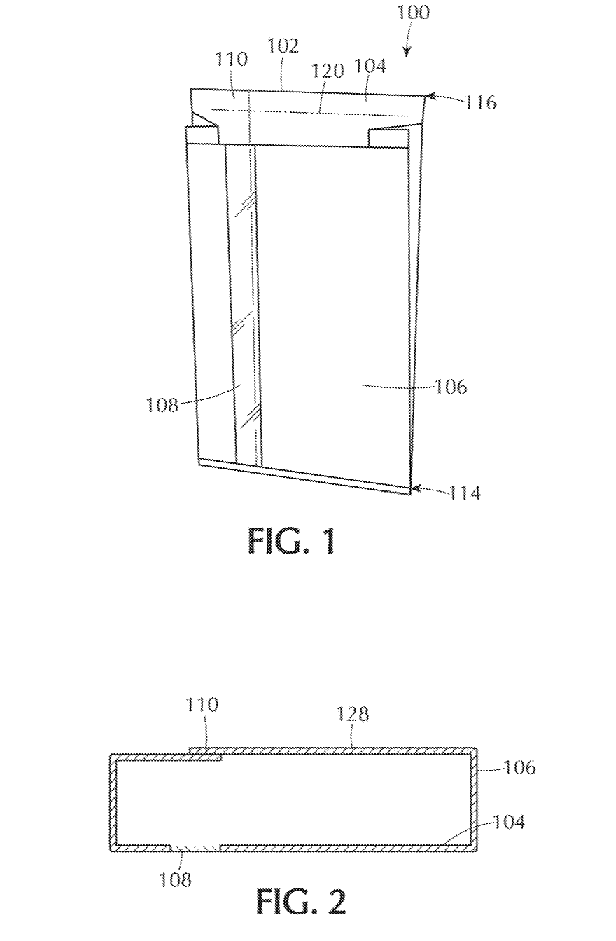

Turning to the figures, FIG. 1 is a schematic perspective view of an exemplary tubular bag showing a fill end that is open. The tubular bag 100 has a laminate structure 102 having a paper layer 104 and an outer layer 106 and a lap seam 110. A window 108 is integral to the laminate structure 102. A bottom seal 112 is formed at closed end 114. A fill end 116 is shown as open. After product is added, the fill end may be closed up using a fill end closure 120 that may be any structure suited for the application. For example, a fill end closure may be a hot melt adhesive seam, a heat seal seam, a sewn seam, a rolled glue seam, or a pressure sensitive adhesive with a liner.

FIG. 2 is a cross-section view of the tubular bag, where, the paper layer 104 is adjacent and adhered to the outer layer 106 which is usually a polymer film. Adhesive layer 128 is between the paper layer 104 and the outer layer 106.

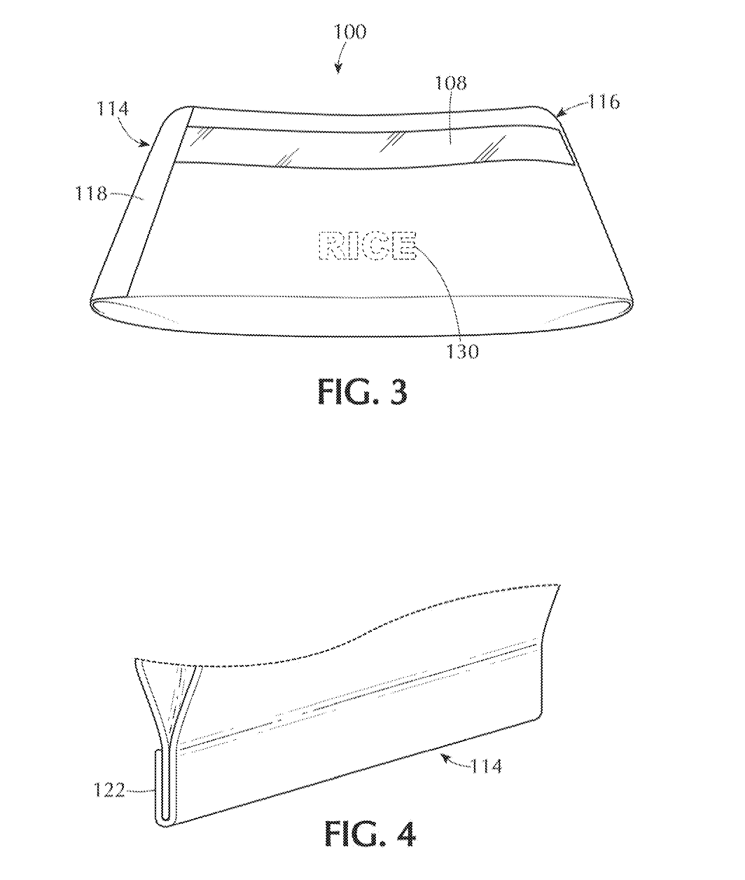

FIG. 3 is a schematic perspective view of an exemplary tubular bag 100 whose fill end 116 is closed with a closure (not numbered). Window 108 and indicia 130 provide information about the goods inside. A reinforcement member 118 is along the closed end 114 and covers the bottom seal 112 in this embodiment.

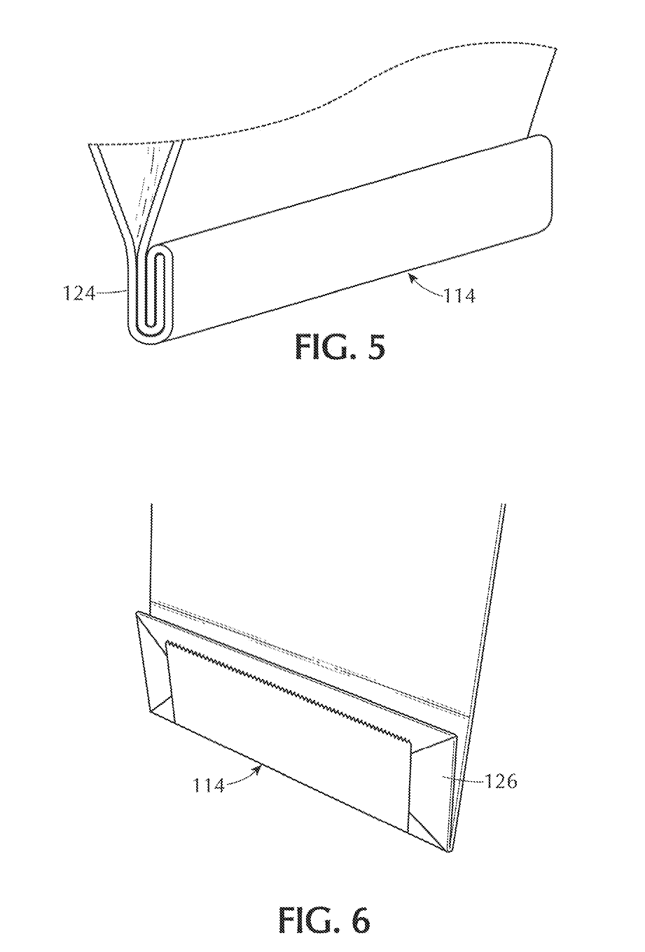

FIGS. 4-6 are schematic drawings of various different bottom seals. FIG. 4 shows a pinch bottom 122 at the closed end 114. FIG. 5 shows a rolled bottom 124 at the closed end 114. FIG. 6 shows a block bottom 126 at the closed end 114.

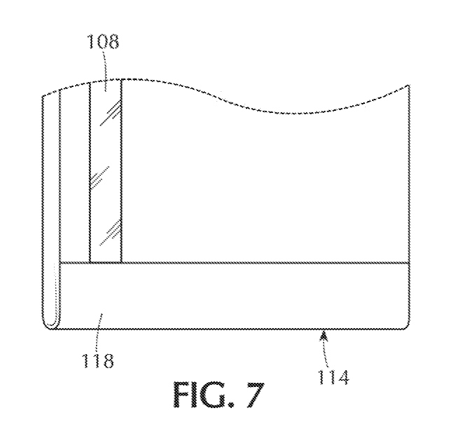

FIG. 7 is a schematic of the reinforcement member, where at the closed end 114, the reinforcement member 118 extends the width of the bag and provides an edge to the window 108.

### EXAMPLE

A pinch bottom open mouth (PBOM) type of bag having a lane window feature was made as follows. A primary unwind contained polymer film comprising a 48-100 gauge polyethylene terephthalate (PET) film. On a secondary unwind, 55#-60# high performance white kraft paper (HPWK) was unwound and slit. An acrylic adhesive was pattern applied to the polymer film using rotogravure. The adhesive was dried and the paper and film were then laminated. This resulted in a film/paper laminate structure with a clear lane.

The film/paper laminate structure was converted into a premade bag with a window for viewing the product. To do this the film/paper laminate structure was formed into a tube with a lap seal and folded to create a gusseted bag. A factory end seal also known as a pinch bottom was formed and a reinforcement member, or in other words a patch, was applied with a polyamide hot melt adhesive. The factory end seal and patch were then folded and compressed. The patch bridged the gap between the paper section and added stiffness. To the open or fill end of the bag was applied a hot melt adhesive for end-user or customer sealing.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A tubular bag for containing a product, the bag comprising:
a laminate structure that comprises an outer layer comprising a polymer film and a paper layer adjacent the outer layer;
a window integral to the laminate structure, the window comprising the polymer film of the outer layer;
a lap seam;
a bottom seal to form a closed end of the bag; and
a fill end opposite the closed end.

2. The tubular bag of claim 1 further comprising a reinforcement member at the closed end of the bag.

3. The tubular bag of claim 2, wherein the reinforcement member covers the bottom seal.

4. The tubular bag of claim 2, wherein the reinforcement member comprises a paper alone or in combination with a polymer film.

5. The tubular bag of claim 1, wherein the bottom seal comprises a pinch bottom, a rolled bottom, or a block bottom.

6. The tubular bag of claim 1, wherein the polymer film is reverse-printed with indicia.

7. The tubular bag of claim 1, wherein the polymer film comprises polyester, nylon, polypropylene, or polyethylene.

8. The tubular bag of claim 1, wherein the paper comprises high performance kraft paper having a weight in the range of from about 40 lb. to about 60 lb. per ream.

9. The tubular bag of claim 1 having a width in the range of from about 8 inches (20 cm) to about 22 inches (56 cm) and a length in the range of about 18 inches (46 cm) to about 42 inches (107 cm).

10. The tubular bag of claim 1, further comprising at least two side gussets along the length of the bag, the gussets extending inwardly at a distance from the side of the bag in the range of from about 2 inches (5 cm) to about 12 inches (30 cm).

11. The tubular bag of claim 1 further comprising a fill end closure for sealing the fill end.

12. The tubular bag of claim 11, wherein the fill end closure comprises a hot melt adhesive seam, a heat seal seam, a sewn seam, a rolled glue seam, or a pressure sensitive adhesive with a liner.

13. The tubular bag of claim 1, wherein the window runs the length of the bag.

14. The tubular bag of claim 1, wherein the window forms up to about 25% of the surface area of the bag.

15. The tubular bag of claim 1, wherein the paper layer is a product-contacting layer.

16. The tubular bag of claim 1 further comprising a barrier layer adjacent the paper layer, the barrier layer being a product-contacting layer.

17. A tubular bag for containing a product, the bag comprising:
a laminate structure that comprises a product-side layer and an outer layer, the product-side layer comprising paper that is kraft paper having a weight in the range of from 40 lb. to about 60 lb. and the outer layer comprising a polymer film that is a polyester film, a polypropylene film, or a nylon film, wherein an adhesive adheres the polymer film to the paper and wherein the outer layer comprises indicia;
a window integral to the laminate structure, the window comprising the polymer film of the outer layer;
a lap seam;
a pinch bottom seal to form a closed end of the bag; and
a fill end opposite the closed end.

18. The tubular bag of claim 17, wherein the polymer film is a polyester film that is polyethylene terephthalate (PET).

19. The tubular bag of claim 17 further comprising a fill end closure that comprises a polyamide hot melt adhesive.

20. The tubular bag of claim 17, wherein the indicia is reverse-printed on the polymer film.

21. A method of making a tubular bag, the method comprising:
unwinding a roll of a polymer film;
unwinding a roll of paper and slitting the paper to form a gap;
applying an adhesive to the polymer film;
laminating the polymer film and the paper such that a laminated structure with an integral window is formed;
forming a lap seal to form a tubular bag; and
sealing one end of the bag to form a closed end.

22. The method of claim 21 further comprising affixing a reinforcement member to the closed end of the bag.

23. The method of claim 21, wherein the polymer film comprises indicia.

24. The method of claim 21 further comprising forming a fill end closure.

25. A method of providing dry goods, the method comprising:
obtaining the tubular bag of claim 1;
packaging the dry food in the bag; and
closing the fill end.

26. The method of claim 25, wherein the dry goods comprise rice, whey products, or flour products.
